(19) United States
(12) Patent Application Publication
(10) Pub. No.: US 2015/0284231 A1
(43) Pub. Date: Oct. 8, 2015

(54) SYSTEMS AND METHODS FOR VALIDATION OF PERSONAL PROTECTION EQUIPMENT ON AERIAL WORK PLATFORMS

(71) Applicant: RF Identity, Inc., Austin, TX (US)

(72) Inventor: Theodore Grant, Austin, TX (US)

(21) Appl. No.: 14/679,769

(22) Filed: Apr. 6, 2015

Related U.S. Application Data
(60) Provisional application No. 61/975,734, filed on Apr. 5, 2014.

(51) Int. Cl. B66F 17/00; G07C 9/00; B66F 11/04

(52) U.S. Cl. CPC B66F 17/006; B66F 11/044; G07C 9/00111

(57) ABSTRACT

Disclosed herein are systems and methods for location-based validation of personal protection equipment (PPE) for use with an aerial work platform (AWP). In one such method, an AWP is provided with a user hub. The user hub stores information identifying one or more radio frequency identification (RFID) tags that are affixed to PPE that is required for the use of the AWP. Through a near-field antenna mounted at the operator basket of the AWP, the user hub determines whether the required PPE is within range of the antenna before permitting a lift operation to be performed by the AWP. In some embodiments, the user hub may disable the AWP or initiate an emergency shutdown if the required PPE is not present.

### CROSS REFERENCE TO RELATED APPLICATIONS

This application is a non-provisional filing claiming priority, pursuant to 35 U.S.C. §119(e) to provisional application U.S. 61/975,734 filed Apr. 5, 2014, the entire contents of which are hereby incorporated herein by reference.

### BACKGROUND

In modern society, there are numerous contexts, both job-related and otherwise, in which it is required that each person (or perhaps each person having a certain role, each person responsible for carrying out a certain function, and the like) at a given site (or perhaps in a particular area within a given site) be wearing and/or in possession of each item in a particular set of what is known in the art as personal protection equipment (PPE).

Fall prevention equipment such as harnesses and lanyards may be required equipment for individuals working at elevated heights, for example when working from an aerial work platform such as a cherry-picker, boom lift, basket crane, scissor lift, or hydraladder. In addition to safety concerns, employers who make use of such devices or and dealers who rent such devices can be exposed to liability if the proper use of personal protection equipment is not adequately enforced.

Other relevant contexts where use of personal protection equipment is advisable, if not required, includes job-related sites such as mines, construction sites, power plants, hospital operating rooms, and the like, and also include non-job-related sites such as recreational skydiving companies, recreational paintball courses, and the like. The particular set of PPE required to be worn by each person in the given area is often mandated by one or more of federal law, state law, company policy, trade-association policy, private contract, group or association rules or by-laws, and/or one or more other authorities, rulemaking bodies, ranking officers, managers, and the like.

### OVERVIEW

Disclosed herein are systems and methods for validating the use of personal protection equipment on aerial work platforms. A user hub provided at an aerial work platform receives and stores information that identifies a near-field identification tag, such as an RFID tag, affixed to personal protection equipment. The user hub is in communication with an antenna mounted at an operator basket of the aerial work platform. The user hub operates to determine whether the near-field identification tag is within range of an antenna mounted on the operator basket. The user hub permits a lift operation to proceed only after determining that the near-field identification tag is within range of the antenna. The user hub may initiate an emergency shutdown after determining that the near-field identification tag is not within range of the antenna. The user hub may check periodically for the continued presence of the near-field identification tag.

Some embodiments take the form of a method carried out by a user hub having a wireless-network interface, a near-field-communication (NFC) interface, a location-determination module, a processor, and data storage containing instructions executable by the processor for carrying out the method, which includes obtaining identity data that uniquely identifies one or both of the user hub and a current user of the user hub. The method also includes acquiring, via the location-determination module, hub-location data that is indicative of a current location of the user hub. The method also includes identifying, via the NFC interface, a set of one or more proximate radio frequency identification device (RFID) tags, each such proximate RFID tag being uniquely associated with a respective item of PPE. The method also includes transmitting, to a server via the wireless-network interface, the identity data, the hub-location data, and a PPE status update indicative of one or both of (i) each RFID tag in the identified set of one or more proximate RFID tags and (ii) each item of PPE uniquely associated with an RFID tag in the identified set of one or more proximate RFID tags.

The above overview is provided by way of example and not limitation, as those having ordinary skill in the relevant art may well implement the disclosed systems and methods using one or more equivalent components, structures, devices, and the like, and may combine and/or distribute certain functions in equivalent though different ways, without departing from the scope and spirit of the present disclosure.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example communication system.

FIG. 2 depicts an example server.

FIG. 3 depicts an example user hub.

FIG. 4 depicts an example radio frequency identification device (RFID) tag.

FIG. 5 depicts an example map of multiple work areas.

FIG. 6 depicts example correlation data relating work areas to required PPE sets.

FIG. 7 depicts example correlation data relating user hubs to associated RFID tags.

FIG. 8 depicts example correlation data relating RFID tags to attached PPE.

FIG. 9 depicts an example method.

FIG. 10 depicts an example aerial work platform.

FIG. 11 depicts an example method.

### DETAILED DESCRIPTION

A detailed description of illustrative embodiments will now be provided with reference to the various drawings. Although this description provides detailed examples of possible implementations, it should be noted that the provided details are intended to be by way of example and in no way to limit the scope of the application.

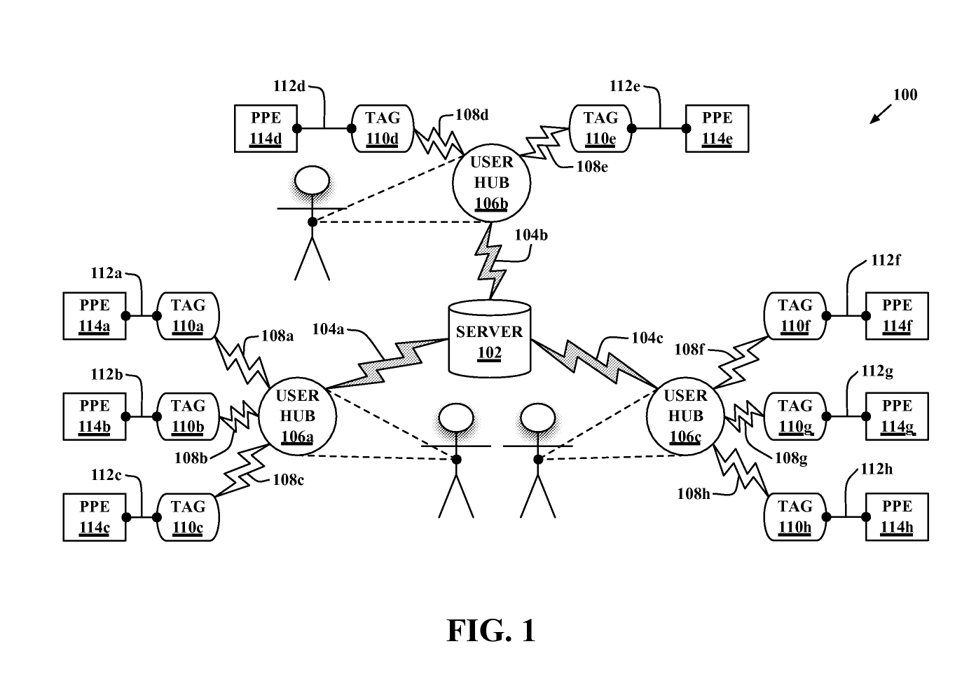

FIG. 1 depicts an example communication system. In particular, FIG. 1 depicts an example communication system 100 that includes a server 102 that communicates wirelessly across an air interface 104a with a user hub 106a, wirelessly across an air interface 104b with a user hub 106b, and wirelessly across an air interface 104c with a user hub 106c.

The user hub 106a communicates wirelessly across the air interface 104a with the server 102, wirelessly across an air interface 108a with a radio frequency identification device (RFID) tag 110a that is physically attached at a connection 112a to an item of PPE (hereinafter referred to at times simply as “a PPE,” or in the plural as “PPEs”) 114a, wirelessly across an air interface 108b with an RFID tag 110b that is physically attached at a connection 112b to a PPE 114a, and wirelessly across an air interface 108c with an RFID tag 110c that is physically attached at a connection 112c to a PPE 114c.

The user hub 106b communicates wirelessly across the air interface 104b with the server 102, wirelessly across an air interface 108d with an RFID tag 110d that is physically attached at a connection 112d to a PPE 114d, and wirelessly across an air interface 108e with an RFID tag 110e that is physically attached at a connection 112e to a PPE 114e.

The user hub 106c communicates wirelessly across the air interface 104c with the server 102, wirelessly across an air interface 108f with an RFID tag 110f that is physically attached at a connection 112f to a PPE 114f, wirelessly across an air interface 108g with an RFID tag 110g that is physically attached at a connection 112g to a PPE 114g, and wirelessly across an air interface 108h with an RFID tag 110h that is physically attached at a connection 112h to a PPE 114h.

Moreover, it can be appreciated from FIG. 1 that (i) there is a 1:1+ (i.e., ‘one’ to ‘one or more’) association between the server 102 and one or more user hubs 106, (ii) there is a 1:1 (i.e., ‘one’ to ‘one’) association between the user hubs 106 and the persons with which the user hubs 106 are respectively uniquely associated, (iii) there is a 1:1+ association between each user hub 106 and one or more RFID tags 110, and (iv) there is a 1:1 association between the RFID tags 110 and the PPEs 114 with which the RFID tags 110 are respectively uniquely associated (and to which the RFID tags 110 are respectively uniquely physically attached at connections 112). Moreover, any numbers of any of these various entities (servers 102, user hubs 106, tags 110, and PPEs 114) could be utilized as deemed suitable by those of skill in the relevant art in various different implementations.

The physical attachments 112 between respective pairs of tags 110 and PPEs 114 could take on any form of physical attachment now known or later developed as deemed suitable by those of skill in the relevant art, where some non-limiting representative examples include clips, pins, clamps, buttons, snaps, stitching, and the like. The various PPEs 114 could take on any form of PPE now known or later developed as deemed suitable by those of skill in the relevant art, where some non-limiting representative examples include headgear, hardhats, clothing, bulletproof vests, radiation suits, flashlights, communication devices, location beacons, footwear, tools, directions, and the like.

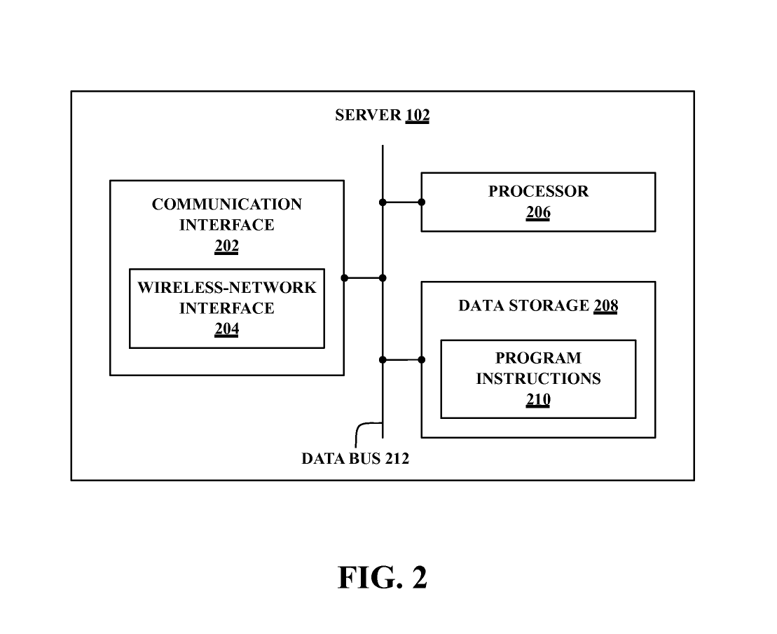

FIG. 2 depicts an example server. In particular, FIG. 2 depicts the server 102 of FIG. 1 as including a communication interface 202 (that itself includes a wireless-network interface 204), a processor 206, and non-transitory data storage 208 (that contains program instructions 210), all of which are communicatively linked by a data bus (or other suitable communication mechanism) 212. In at least one embodiment, the server 102 is distributed across multiple devices. In at least one such embodiment, the wireless-network interface 204 takes the form of or at least includes one or more devices such as base stations, access points, and the like, where such one or more devices communicate over a communication link 212 with one or more other devices that handle one or more of the other functions (e.g., back-end data processing, data storage, and the like) described herein in connection with the server 212.

The communication interface 202 may include any number of wired-communication (e.g., Ethernet) interfaces, but in some embodiments does not include any wired-communication interfaces. Furthermore, the communication interface 202 may include any number of wireless-communication (e.g., cellular, Wi-Fi, Bluetooth, RF, infrared, and the like) interfaces, but in some embodiments only includes the wireless-network interface 204.

The wireless-network interface 204 includes any necessary hardware (e.g., antennas, chipsets, processors, memory, channel elements, and/or the like) and any necessary instructions (in the form of, e.g., hardwired instructions, firmware instructions, and/or software instructions) to conduct wireless communications over the air interfaces 104a, 104b, and 104c with the user hubs 106a, 106b, and 106c, respectively. Server 102 may conduct such wireless communications over the air interfaces 104 with the user hubs 106 according to any one or more wireless-communication formats and/or protocols deemed suitable by those of skill in the art for a given implementation. As examples and not by way of limitation, some such wireless-communication formats and protocols that could be used include RF, cellular wireless, time division multiple access (TDMA), code division multiple access (CDMA), frequency division multiple access (FDMA), orthogonal frequency division multiple access (OFDMA), Evolution Data Optimized (EV-DO), Long Term Evolution (LTE), Wi-Fi, WiMAX, Global System for Mobile communications (GSM), general packet radio service (GPRS), Universal Mobile Telecommunication System (UMTS), and the like.

The processor 206 may include one or more processors of any types deemed suitable by those of skill in the relevant art, with some representative examples including microprocessors, central processing units (CPUs), digital signal processors (DSPs), and the like. Data storage 208 may include one or more instances of one or more types of non-transitory data storage deemed suitable by those having skill in the relevant art, with some representative examples including read only memory (ROM), random access memory (RAM), disk-based storage, flash memory, optical-storage technology, and the like. In at least one embodiment, data storage 208 contains program instructions 210 that are executable by the processor 206 for carrying out the server functions described herein.

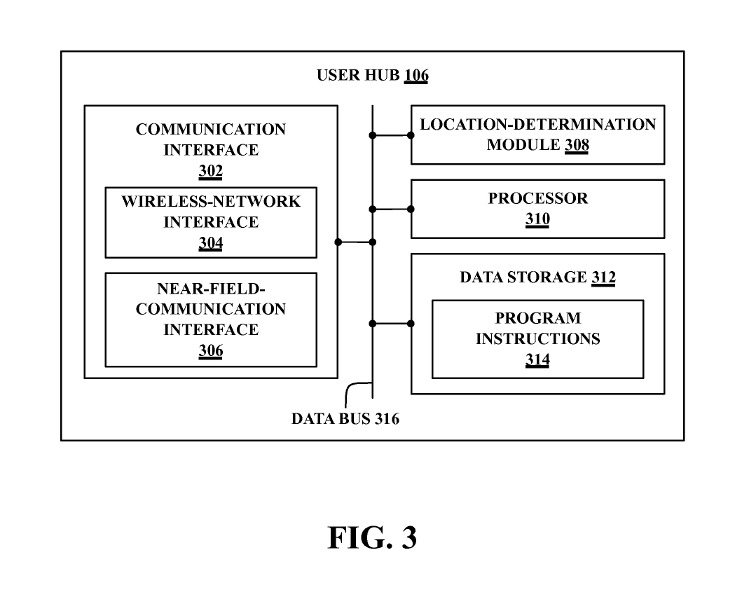

FIG. 3 depicts an example user hub. In particular, FIG. 3 depicts the user hub 106 (i.e., 106a, 106b, and/or 106c) from FIG. 1 as including a communication interface 302 (that itself includes a wireless-network interface 304 and an NFC interface 306), a location-determination module (LDM) 308, a processor 310, and non-transitory data storage 312 (that contains program instructions 314), all of which are communicatively linked by a data bus (or other suitable communication mechanism) 316. In at least one embodiment, the user hub 106 is (or is included as a physical and/or functional component of) a mobile device such as an access terminal, a mobile station, a cellular phone, a smartphone, a tablet computer, and the like, and as such may well contain one or more additional components not depicted in FIG. 3 such as but not limited to a user interface.

The communication interface 302 may include any number of wired-communication (e.g., Ethernet) interfaces, but in some embodiments does not include any wired-communication interfaces. Furthermore, the communication interface 302 may include any number of wireless-communication (e.g., cellular, Wi-Fi, Bluetooth, RF, infrared, and the like) interfaces, but in some embodiments only includes the wireless-network interface 304 and the NFC interface 306. In at least one embodiment, the wireless-network interface 304 takes the form of a client-side interface compatible with the above-described server-side (a.k.a. network-side) wireless-network interface 204 of the server 102, and thus may operate according to any of the formats and protocols listed in connection with the wireless-network interface 204, and/or one or more other suitable formats and/or protocols.

The NFC interface 306 includes any necessary hardware (e.g., antennas, chipsets, processors, memory, channel elements, and/or the like) and any necessary instructions (in the form of, e.g., hardwired instructions, firmware instructions, and/or software instructions) to conduct wireless communications over the air interfaces 108 with the RFID tags 110. As is known in the relevant art, the NFC 306 interface may be operable to generate an interrogating signal to which one or more RFID tags will respond with tag-identifying data and/or perhaps other data as well. As examples, such a signal may be generated within one of any number of RF bands, such as 13.56 MHz, 433 MHz, 865-868 MHz, 902-928 MHz, 2450-5800 MHz (i.e., 2.45-5.80 GHz), 3.1-10 GHz, and/or one or more other RF bands deemed suitable by those of skill in the art in a given context. NFC 306 may implement RFID standards promulgated by organizations such as EPCglobal (a GS1 venture), the International Electrotechnical Commission (IEC), the International Standards Organization (ISO), and the Joint Technical Committee (JTC 1), a committee formed by ISO and IEC.

In some embodiments, the NFC interface 306 embodies NFC technologies such as Bluetooth, Wi-Fi, and the like, in which case the tags 110 would be equipped with corresponding communication technology. In some embodiments, the user hub 106 operates one or more applications (i.e., “apps”) that manage communication via NFC interface 306 with a set of tags 110, and that may also manage communication via wireless-network interface 304 with the server 102. In at least one embodiment, the wireless-network interface 304 operates according to a first wireless-communication format, and the NFC interface 306 operates according to a second wireless-communication format different from the first.

The location-determination module 308 may include and/or make use of one or more location-determination (a.k.a., position-determination) technologies such as Global Positioning System (GPS) technology, wireless-network-based (e.g., cellular-network-based, Wi-Fi-network-based, and the like) triangulation technology, dead-reckoning technology, and/or one or more other types of location-determination technologies now known or later developed, as deemed suitable in a given context by those of skill in the relevant art.

Moreover, the hardware and instructions utilized in various implementations to determine a location of a user hub 106 could be implemented on the server 102, on the user hub 106, on one or more other network devices, and/or on some combination of those. Thus, in some embodiments, the LDM 308 may function to fully determine the location of user hub 106. In other embodiments, the LDM 308 may convey information (signal-strength information and/or time-distance-of-arrival (TDOA) information pertaining to one or more transmitters and/or transceivers (e.g., one or more work-area-specific transmitters and/or transceivers), raw GPS (i.e., ephemeris) data, and/or the like) to one or more network entities such as the server 102, for use by such one or more network entities in determining the location of the user hub 106. And certainly other arrangements could be used. Furthermore, a location of a user hub 106 could be expressed in a number of different ways, including but not limited to GPS location, latitude and longitude, being within a given work area, being within a given distance of a given transmitter and/or transceiver, a Cartesian coordinate point overlaid on a particular map or work site, and/or any other suitable expression of location.

The processor 310 and data storage 312 may take any suitable forms, including but not limited to one or more of those described above in connection with the processor 206 and the data storage 208 of FIG. 2, though of course the stored program instructions 314 are executable by the processor 310 for carrying out the user-hub functions described herein.

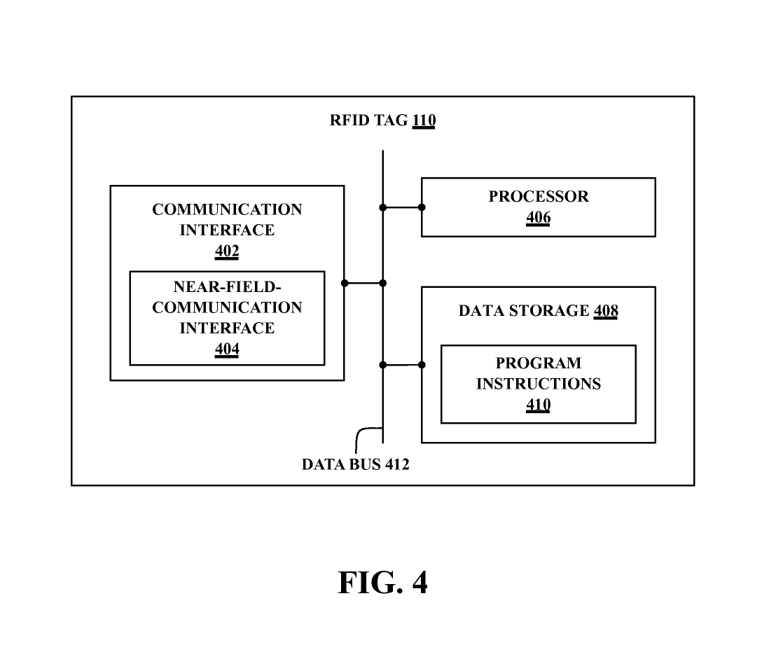

FIG. 4 depicts an example RFID tag. In particular, FIG. 4 depicts an RFID tag 110 (i.e., 110a, 110b, 110c, . . . , 110h) from FIG. 1 as including a communication interface 402 (that itself includes an NFC interface 404), a processor 406, and non-transitory data storage 408 (that contains program instructions 410), all of which are communicatively linked by a data bus (or other suitable communication mechanism) 412. One or more of the RFID tags 110 could be passive RFID tags, active RFID tags, battery-assisted passive RFID tags, and/or one or more of any other type of RFID (or other NFC-capable) tags (or other communication devices) deemed suitable by those of skill in the relevant art for a given context.

The communication interface 402 may include any number of communication interfaces, but in some embodiments only includes the NFC interface 404, which may take the form of or at least include a client-side interface compatible with the above-described NFC interface 306 of the user hub 106, and thus may operate according to any of the formats and protocols listed in connection with the NFC interface 306, and/or one or more others. In an embodiment, the NFC interface 404 includes hardware and instructions arranged and configured to respond to an interrogating signal such as that described above in connection with FIG. 3 by providing tag-identifying data and/or perhaps additional data as well. The processor 406 and the data storage 408 may take any suitable forms, including but not limited to one or more of those described above in connection with the processor 206 and the data storage 208 of FIG. 2, though of course the stored program instructions 410 are executable by the processor 406 for carrying out the RFID-tag functions described herein.

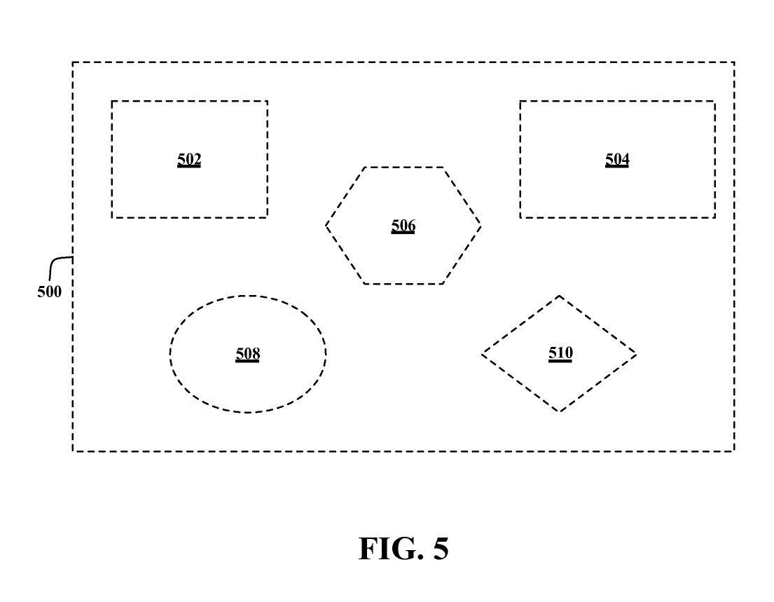

FIG. 5 depicts an example map of multiple work areas. In particular, FIG. 5 depicts a map 500 containing rectangular work areas 502 and 504, hexagonal work area 506, elliptical work area 508, and diamond-shaped work area 510. In a given context, any number of work areas could be defined, as five are depicted here by way of example only. Also, each work area could have the same shape, each could have a different shape, and in fact each work area could be defined to have any shape suitable for a given context. In an embodiment, the map 500 corresponds as an overall matter to a single job site, and each of the work areas 502-510 correspond to regions where particular types of work are being done, where each such work area 502-510 is associated with a set of required PPEs that must be worn by each person in the respective work area.

Two or more work areas 502-510 could be associated with identical sets of PPEs, though it could also be the case that each work area 502-510 is associated with a set of PPEs that is unique to that work area. Moreover, while the work areas 502-510 are described in this example as being worksite-related or job-related, in fact these areas 502-510 could correspond to different recreational activities (archery, wood chopping, etc.), and certainly a multiple-area map such as the map 500 could include some areas that are job-related, some that are recreation-related, some that are religion-related or worship-related, and/or some areas dedicated to any other purpose or purposes. Also, the area that is within the rectangular map 500 but not within one of the designated work areas 502-510 could also be designated as a default area or general area of sorts, perhaps having its own associated set of required PPEs. In general, then, the presently disclosed systems and methods enable workers or other personnel to be mobile among multiple work areas, each having its own associated set of required PPEs for people in the particular areas, all while monitoring and validating continued compliance with the differing and varying requirements placed on such personnel by the demands and characteristics of the differing and varying work areas.

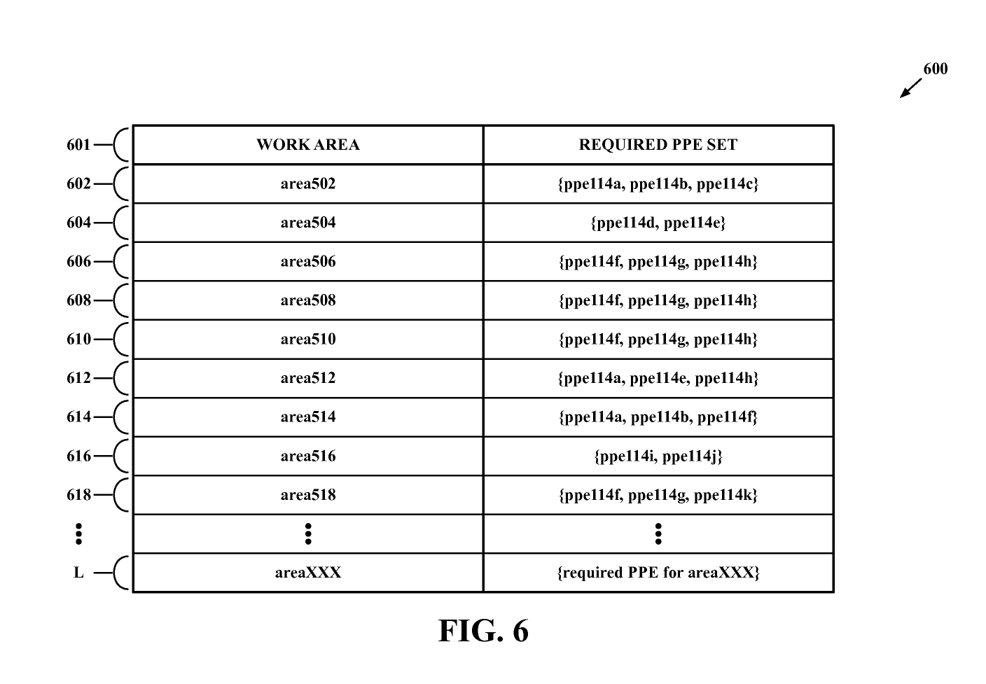

In various different embodiments, various different sets of data are stored by one or more of the various entities described herein, such as the server 102, the user hubs 106, the RFID tags, 110, and the like. FIGS. 6, 7, and 8 depict three example sets of correlation data that may be stored and used by one or more such entities. In each case, the respective set of correlation data (which may also be referred to at various times as a data table, an array, a spreadsheet, and the like) may be stored in any of the data-storage components described herein in connection with various different entities and devices, and instead or in addition could be stored in any non-transitory data storage deemed suitable by those of skill in the relevant art in a given context or for a given implementation. Moreover, any or all of the sets of correlation data described herein may be organized in a different way, and may include different respective numbers of data records, as the manners of organization (i.e., a table of rows and columns) and the depicted numbers of data records are provided purely by way of example and for illustration, and not by way of limitation.

FIG. 6 depicts example correlation data relating work areas to required PPE sets. In particular, FIG. 6 depicts a data table 600 having two columns that are respectively titled “Work Area” and “Required PPE Set,” as shown in the title bar 601 of the data table 600. Furthermore, the data table 600 also is depicted as having rows 602, 604, . . . , 616, 618, . . . , L, where “L” is simply a representation of an arbitrary last row of the data table 600. Each row 602-L includes an identifier of a work area (in the first column) corresponding to a set of identifiers of PPE that is required of each person at that work area (in the second column) As a first example, the row 602 contains a work-area identifier “area 502” corresponding to a set of PPE identifiers {ppe114a, ppe114b, ppe114c}. As a second example, the row 616 contains a work-area identifier “area516” corresponding to a set of PPE identifiers {ppe114i, ppe114j}. For illustration and not by way of limitation, the rows 602-610 correspond to the work areas 502-510 of FIG. 5.

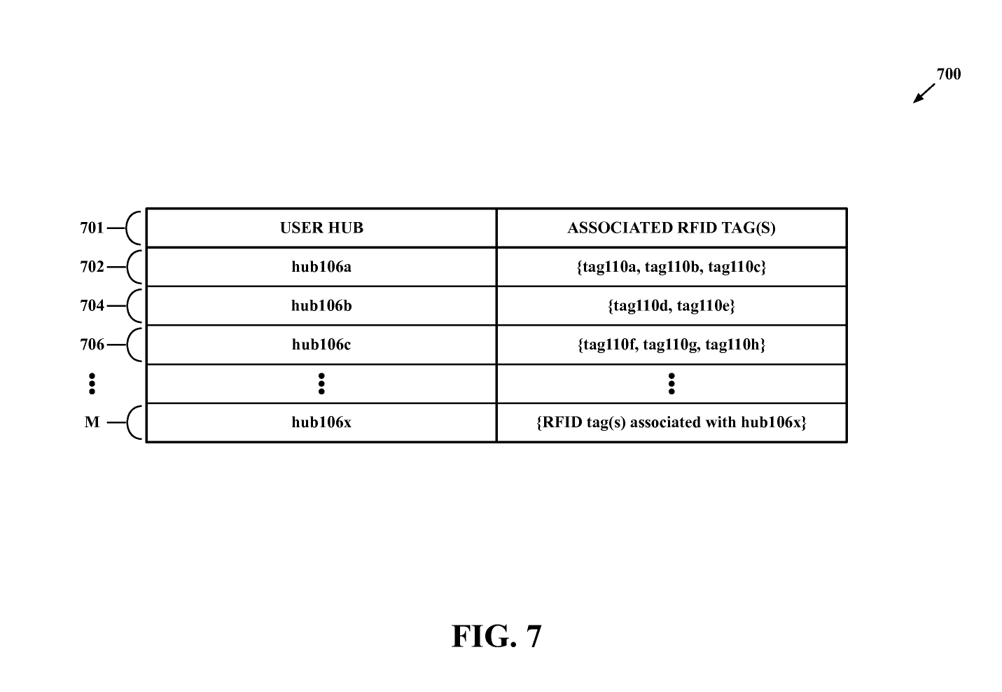

FIG. 7 depicts example correlation data relating user hubs to associated RFID tags. In particular, FIG. 7 depicts a data table 700 having two columns that are respectively titled “User Hub” and “Associated RFID Tag(s),” as shown in the title bar 701 of the data table 700. Furthermore, the data table 700 also is depicted as having rows 702, 704, 706, . . . , M, where “M” is simply a representation of an arbitrary last row of the data table 700. Each row 702-M includes an identifier of a user hub 106 (in the first column) corresponding to a set of identifiers of RFID tags 110 with which that user hub 106 is associated. As a first example, the row 702 contains a user-hub identifier “hub106a” corresponding to a set of RFID-tag identifiers {tag110a, tag110b, tag110c}. As a second example, the row 706 contains a user-hub identifier “hub106c” corresponding to a set of RFID-tag identifiers {tag110f, tag110g, tag110h}. For illustration and not by way of limitation, the rows 702, 704, and 706 correspond respectively to the user hubs 106a, 106b, and 106c of FIG. 1.

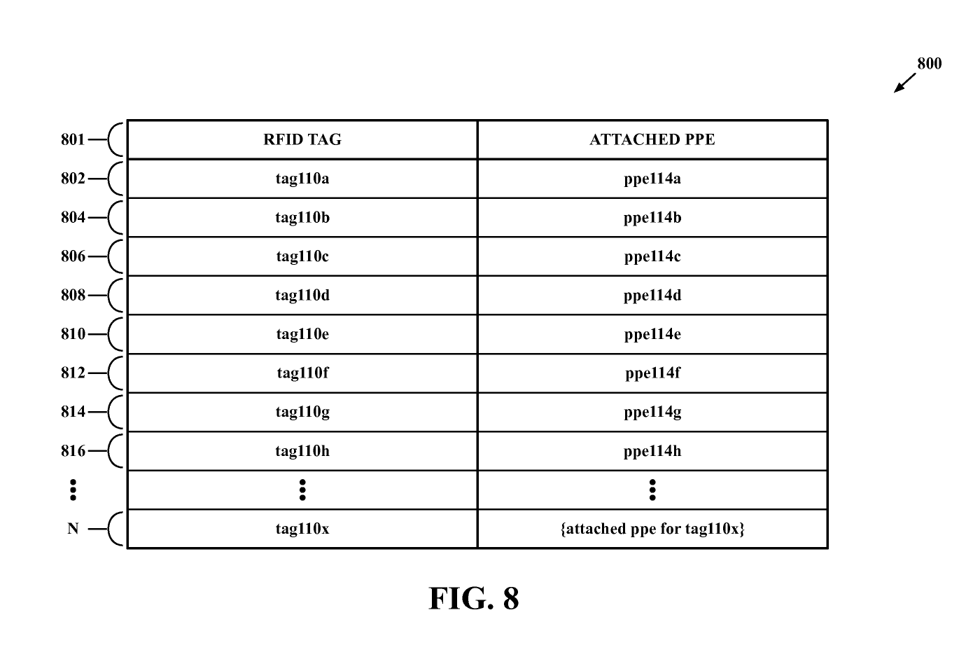

FIG. 8 depicts example correlation data relating RFID tags to attached PPE. In particular, FIG. 8 depicts a data table 800 having two columns that are respectively titled “RFID Tag” and “Attached PPE,” as shown in the title bar 801 of the data table 800. Furthermore, the data table 800 also is depicted as having rows 802, 804, . . . , 814, 816, . . . , N, where “N” is simply a representation of an arbitrary last row of the data table 800. Each row 802-N includes an identifier of an RFID tag 110 (in the first column) corresponding to an identifier of a PPE 114 with which that RFID tag 110 is uniquely associated, and to which that RFID tag 110 is uniquely physically attached. As a first example, the row 802 contains RFID-tag identifier “tag110a” corresponding to a PPE identifier “ppe114a.” As a second example, the row 802 contains RFID-tag identifier “tag110a” corresponding to a PPE identifier “ppe114a.” For illustration and not by way of limitation, the rows 702, 704, and 706 correspond respectively to the user hubs 106a, 106b, and 106c of FIG. 1.

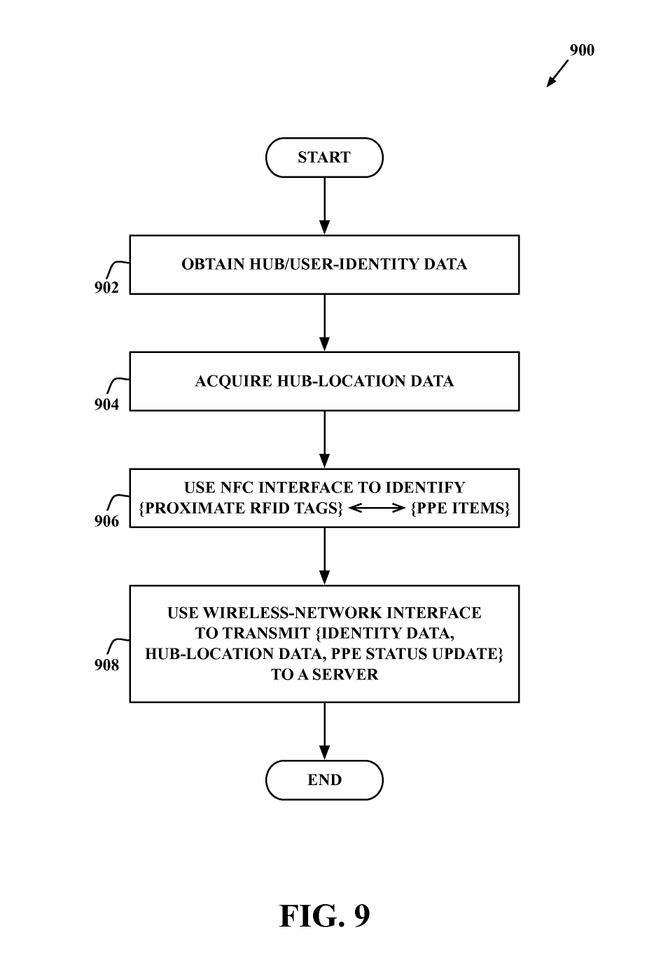

FIG. 9 depicts an example method 900 that in at least one embodiment is carried out by a user hub such as the user hub 106. For illustration and not by way of limitation, the method 900 is described as being carried out by the user hub 106a. In other embodiments, the method 900 is carried out by a combination of a user hub 106 and one or more other entities, such as one or more of the other entities described herein and/or one or more entities not described herein, as deemed suitable by those of skill in the relevant art for a given context. In the embodiment described below, the method 900 includes steps (aka functions) 902, 904, 906, and 908, each of which are discussed in the ensuing paragraphs.

At step 902, the user hub 106a obtains identity data that uniquely identifies one or both of the user hub 106a and a current user of the user hub 106a. In at least one embodiment, step 902 involves the user hub 106a reading the identity data from the data storage 312. Data that uniquely identifies the user hub 106a itself could include one or more of a hardware serial number (e.g., an electronic serial number (ESN)), a Media Access Control (MAC) address, an Internet Protocol (IP) address, a mobile identification number (MIN), and/or one or more other suitable permanent or semi-permanent (e.g., assigned) identifiers deemed suitable by those of skill in the relevant art in a given context. Data that uniquely identifies the current user of the user hub 106a could include one or more of a name, a date of birth, an employee number, a driver's license number, a passport number, a login, a combination of a login and password, an electronic certificate or other electronic identification and/or authentication token, an e-mail address, a network address identifier (NAI), and/or one or more other suitable permanent or semi-permanent (e.g., assigned) identifiers deemed suitable by those of skill in the relevant art in a given context.

At step 904, the user hub 106a acquires, via the location-determination module 308, hub-location data that is indicative of a current location of the user hub 106a. As described above, in at least one embodiment, the location-determination module 308 includes a GPS receiver. In such embodiment, then, the hub-location data may include location information ascertained by that GPS receiver. In at least one embodiment, such as but not limited to the aforementioned GPS example, the hub-location data that is acquired in step 904 includes the current location of the user hub. In at least one other embodiment, however, the hub-location data that is acquired in step 904 includes data that enables derivation (by, e.g., the server 102) of the current location of the user hub 106a. As described above in connection with FIG. 3, such data could include one or more of GPS ephemeris data, TDOA and/or signal-strength information regarding signals from one or more transmitters (e.g., location beacons), transceivers, and the like.

In an example, the user hub 106a carries out the method 500 in the context of the map 500 of FIG. 5. In this example, each of the depicted work areas 502-510 has near its respective center a location beacon that repeatedly transmits a signal that is (i) receivable and decodable by the user hub 106a using the location-determination module 308 and (ii) unique (at least among the depicted work areas 502-510) to the work area in which its transmitting beacon is positioned. At a particular example moment within this larger described example, the user hub 106a determines by using its location-determination module 308 that, among the work areas 502-510, the user hub 106a is in work area corresponding beacon is located. In a first example instance, then, the user hub 106a may use its location-determination module 308 to ascertain that the user hub 106a is currently located within the (hexagon-shaped) work area 506. In a second example instance, perhaps later that day, the user hub 106a may use its location-determination module 308 to ascertain that the user hub 106a is currently located within the (rectangle-shaped) work area 502. These first and second example instances are referenced and further described below.

At step 906, the user hub 106a identifies, via (i.e., using) the NFC interface 306, a set of one or more proximate RFID tags 110. As described above, each RFID tag 110 in the set of proximate RFID tags 110 is uniquely associated with a respective item of PPE 114. In at least one embodiment, each RFID tag 110 in the set of one or more proximate RFID tags 110 is physically connected to the respective item of PPE 114 with which that tag 110 is uniquely associated. In at least one embodiment, carrying out step 906 involves receiving a respective presence message from each tag 110 in the set, where each such presence message identifies one or both of the corresponding tag 110 and the item of PPE 114 that is uniquely associated with the corresponding tag 110. In at least one such embodiment, the user hub 106a uses one or more of the received presence messages for compiling the PPE status update that is described below in connection with step 908. In at least one embodiment, the user hub 106a receives the one or more aforementioned presence messages after transmitting at least one interrogating signal via the NFC interface 306.

At step 908, the user hub 106a transmits, to the server 102 via the wireless-network interface 304, the (i) identity data obtained in step 902, (ii) the hub-location data acquired in step 904, and (iii) a PPE status update that is indicative of one or both of (a) each RFID tag 110 in the set of one or more proximate RFID tags 110 identified in step 906 and (b) each item of PPE 114 that is uniquely associated with an RFID tag 110 in the set of one or more proximate RFID tags 110 identified in step 906. Thus, in at least one embodiment, the PPE status update identifies each RFID tag 110 in the set of one or more proximate RFID tags 110 identified in step 906, perhaps in the form of a list of RFID-tag identifiers received by the user hub 106a via the NFC interface 306.

Furthermore, in at least one embodiment, the PPE status update identifies (in addition to or instead of identifying the corresponding RFID tags 110) each item of PPE 114 that is uniquely associated with an RFID tag 110 in the set of one or more proximate RFID tags 110 identified in step 906. In such embodiments, each RFID tag 110 could be provisioned not only with an identifier of itself, but also with an identifier of the PPE 114 with which it is uniquely associated (perhaps at the very time that the RFID tag 110 is physically affixed to the given item of PPE 114), and accordingly the RFID tags 110 could convey their tag identifier and PPE 114 identifier in messages such as the above-mentioned presence messages sent to the user hub 106a using near-field communication. In other such embodiments, the user hub 106a maintains in data storage 312 a table such as the data table 800 of FIG. 8, and thus be able to reference that data table in order to map RFID-tag identifiers to attached-PPE identifiers. In other embodiments, the server 102 maintains a table such as the data table 800 in order to be able to conduct such data mapping. In other embodiments, both the server 102 and the user hub 106a maintain such data tables, where in some such cases the data in those respective tables is synchronized. And certainly other arrangements could be used, as deemed suitable by those of skill in the relevant art in a given context or for a given implementation.

In at least one embodiment, the PPE status update includes an indication of compliance or non-compliance with a particular required set of PPE; in such embodiments, the user hub 106a generates this indication of compliance or non-compliance based at least in part on a comparison of (i) the particular required set of PPE and (ii) the one or more items of PPE 114 uniquely associated with an RFID tag 110 in the set of one or more proximate RFID tags 110 identified in step 906. In at least one such embodiment, the user hub 106a receives, via the wireless-network interface 304 from the server 102, PPE-requirement data indicative of the particular required set of PPE, and in some such cases the server 102 had transmitted that PPE-requirement data to the user hub 106a based at least in part on the hub-location data acquired in step 904 (which the user hub 106a could certainly transmit to the server 102 as part of one or more messages separate from one or more messages used to convey, e.g., the herein-described PPE status update). In at least one embodiment, the PPE status update consists of an indication of compliance or non-compliance with the particular required set of PPE. And certainly numerous other approaches could be used, as deemed suitable by those of skill in the relevant art in a given context or for a given implementation.

Moreover, in at least one embodiment, a subset (i.e., one or more but not all) of the steps 902, 904, 906, and 908 is carried out periodically, i.e. at regular time intervals. In at least one such embodiment, that subset includes steps 906 and 908; and in at least one of those embodiments, the subset also includes step 906. And in at least one embodiment, the user hub 106a carries out the entire method 900 periodically.

Moreover, in at least one embodiment, a subset (i.e., one or more but not all) of the steps 902, 904, 906, and 908 is carried out responsive to the user hub 106a receiving a PPE-status request from the server 102 via the wireless-network interface 304. In at least one such embodiment, that subset includes steps 906 and 908; and in at least one of those embodiments, the subset also includes step 906. And in at least one embodiment, the user hub 106a carries out the entire method 900 responsive to receiving a PPE-status request from the server 102 via the wireless-network interface 304.

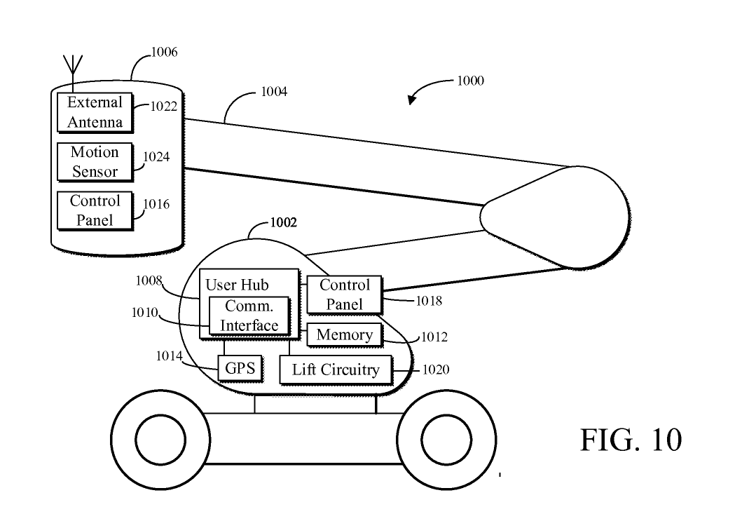

An embodiment of an RFID-based safety system for an aerial work platform (AWP) is illustrated in FIG. 10. The system is implemented in an aerial work platform 1000. The aerial work platform 1000 may be, for example, a cherry-picker, boom lift, basket crane, scissor lift, hydraladder, or other such device. The aerial work platform 1000 may be self-propelled, or it may be a trailer-based device. Aerial work platforms are capable of raising a user to a substantial height. As a result, the user of such a platform can be exposed to a risk of injury from a fall if proper precautions are not taken. One precaution that can be taken is for the user to wear proper personal protection equipment (PPE) for fall prevention, such as a harness or lanyard. The aerial work platform 1000 operates to encourage proper use of personal protection equipment during operation of the platform.

As illustrated in FIG. 10, the aerial work platform 1000 has a base 1002 on which a boom arm 1004 is mounted. The boom arm 1004 is capable of raising and lowering an operator basket 1006 to provide an elevated work platform. The boom arm 1004 may be operated hydraulically, though the use of other drive systems, such as worm gears, is also contemplated.

The aerial work platform is provided with a user hub 1008 that operates in accordance with principles described above with respect to user hub 106. The user hub 1008 includes a communication interface 1010 and a memory 1012. The communication interface 1010 includes a near-field communication interface capable of reading RFID tags. The communication interface 1010 in some embodiments includes additional communication interfaces, such as a Bluetooth interface, an interface with a cellular data network, LF, HF, UHF, Wi-Fi, or other wired or wireless interface. The user hub 1008 may also be in communication with a global positioning system (GPS) receiver 1014.

In some embodiments, the aerial work platform 1000 has two control panels, a first control panel 1016 located in the operator basket and a second control panel 1018 located at the base 1002. The control panels 1016 and 1018 are operative to control lift circuitry 1020. In some embodiments, such as electric over hydraulic control systems, lift circuitry 1020 is operative to control the hydraulics (or other systems) that operate the boom arm 1004. In other embodiments, such as systems with hydraulic user controls, the lift circuitry 1020 may be operative to control only some functions of the aerial work platform 1000, such as emergency disable functions.

The aerial work platform 1000 is operative to activate emergency shutdown features in the absence of proper personal protection equipment. To do this, the user hub 1008 in some embodiments employs an external antenna 1022 in the operator basket 1006. The user hub 1008 may communicate with the external antenna 1022 through a wired connection or, in some embodiments, through a wireless connection such as a Wi-Fi connection. In other embodiments, the user hub 1008 itself is located in the operator basket 1006. In such embodiments, the external antenna 1022 may be replaced by an internal antenna. Preferably, the antenna 1022 is positioned on the operator basket 1006, regardless of whether the user hub 1008 is also located at the operator basket 1006.

The memory 1012 of the user hub 1008 stores RFID identifiers for RFID tags that are affixed to required items of personal protection equipment. For example, it may be desirable for a particular item of personal protection, such as a lanyard, harness or other fall protection equipment, to be used with the aerial work platform 1000. A particular RFID tag may be fixed to the personal protection equipment, for example by being attached to or embedded in the equipment. The identifier associated with that RFID tag may then be stored in the memory 1012 of the aerial work platform to associate that personal protection equipment with the user hub 1008 (and thus with the aerial work platform 1000). The process of associating personal protection equipment with an aerial work platform 1000 may be performed wirelessly. For example, in embodiments in which the communication interface 1010 of the user hub 1008 includes a wireless network interface such as Wi-Fi, LTE, or other wireless data collection, an administrator may communicate with the user hub 1008 over a network (such as the Internet or a LAN) to identify the RFID identifier associated with a required piece of personal protection equipment. The hub 1008 may, for example, be supplied with HTTP server software (which may be stored in the memory 1012) to provide a network interface that permits entry of RFID identifiers. Such a system or other alternative interfaces would allow an equipment manager or other administrator to access the user hub 1008 to assign specific personal protection equipment to the aerial work platform 1000.

For example, a construction equipment rental company could access the user hub 1008 over a network prior to an asset being rented to the end user. The rental company would scan the personal protection equipment or enter a unique tag identification number and an identification number associated with the aerial work platform. After the personal protection equipment or unique tag has been assigned to the asset, the asset safety system would be enabled. The assignment of a tag to a particular aerial work platform may be effective for the length of the rental or intended use, and the administrator may still be provided with wireless access to the user hub 1008 to update the tag status while the unit is deployed in the field.

In some embodiments, when the RFID or other near-field tag of the personal protection equipment is in range of the antenna 1022, the aerial work platform would be fully functional. In the event that the tagged personal protection equipment or tag is out of range of the antennae, the user hub 1008 causes the lift circuitry 1020 to disable at least some the lifting functions of the boom arm 1004. Aerial work platforms are often provided with an emergency shutdown system that is accessible from the operator basket 1006. The lift circuitry 1020 may interface with the emergency shutdown controls to activate the emergency shutdown system. Preferably, the disabling of the aerial work platform does not interfere with the operation of other emergency systems, such as ground-based emergency functions operable from the control panel 1018 on the base 1002.

When a user of the aerial work platform 1000 engages the lifting functions, the user hub 1008 sends a signal through the antenna 1022 to determine whether a tag associated with required personal protection equipment is in range. If the tag is not present, the user hub 1008 engages the emergency shutdown.

In some embodiments the system is operative to determine whether required personal protection equipment has been left on the ground. In such embodiments, the tag affixed to the personal protection equipment may be out of range of the antenna 1022 once the operator basket 1006 has moved into an elevated position. Once the user is out of range, the user hub 1008 engages the emergency shutdown. A test for whether the tag is out of range may be performed when the operator basket 1006 reaches a threshold height such as, for instance, six feet in the air. The height of the operator basket 1006 may be measured with an altimeter or may be calculated based on time and lift height speed. For example, a lift that has a lift speed of three feet per second reaches a threshold height of six feet in two seconds. As an alternative technique for determining whether the personal protection equipment has been left out of the operator basket 1006, the antenna 1022 and user hub 1008 may operate to measure the distance of the personal protection equipment from the antenna 1022. In some embodiments, the testing for personal protection equipment at the threshold height may be performed instead of the pre-lift testing 1108, 1110.

The user hub 1008 may operate intermittently or periodically to check for the presence of an appropriate tag, or it may check only when the lift starts to go up, or it may check when the drive system is engaged to move the lift when the basket is in the air. The protocol used to check for the presence of required personal protection equipment can be implemented by software stored as computer-readable instructions in non-transitory memory 1012. The hub 1008 may be programmed to follow a specific protocol, or the software may be capable of operating with several protocols selectable by an administrator.

The memory 1012 of the aerial work platform 1000 may also include information identifying particular geographic locations at which operation of the aerial work platform 1000 is permitted. In such embodiments, the lift functions of the aerial work platform 1000 may be disabled unless the aerial work platform 1000 is located in a permitted work zone.

In some embodiments, for example when the aerial work platform 1000 is being rented to a customer, it is beneficial to determine how long the equipment is in use, so the customer can be charged accordingly. A timer can be coupled to the overall system power, but such a timer can lead to misleading results because a customer renting the equipment could simply raise the lift and then turn off the power while still performing work from the lift. In some embodiments, the user hub 1008 is capable of measuring how many hours someone was in the basket 1006 and the lift was in operation. When the lift is down and in a stowed position, the user hub 1008 would not read the personal protection equipment in the event that the tags were simply left on the unit for storage.

The user hub may be tied into a key that is located at the ground controls 1018, allowing the HUB to be disabled when the machine is shutdown.

The aerial work platform 1000 may also be provided with one or more motion sensors 1024 on the basket 1006 and/or on the boom arm 1004. The motion sensor 1024 may include a gyroscope, and angle sensor, an accelerometer, or other device capable of reading changes in the position of the basket 1006 and/or boom arm 1004. The user hub 1008 is in communication with the motion sensor or sensors 1024 and logs events relating to the use of the aerial work platform 1000 in the memory 1012. The user hub 1008 may be operative to shut down the lift if the motion sensors 1024 detect unsafe conditions, such as a condition in which the lift is not level, or a condition in which the boom arm is not moving properly in response to input controls.

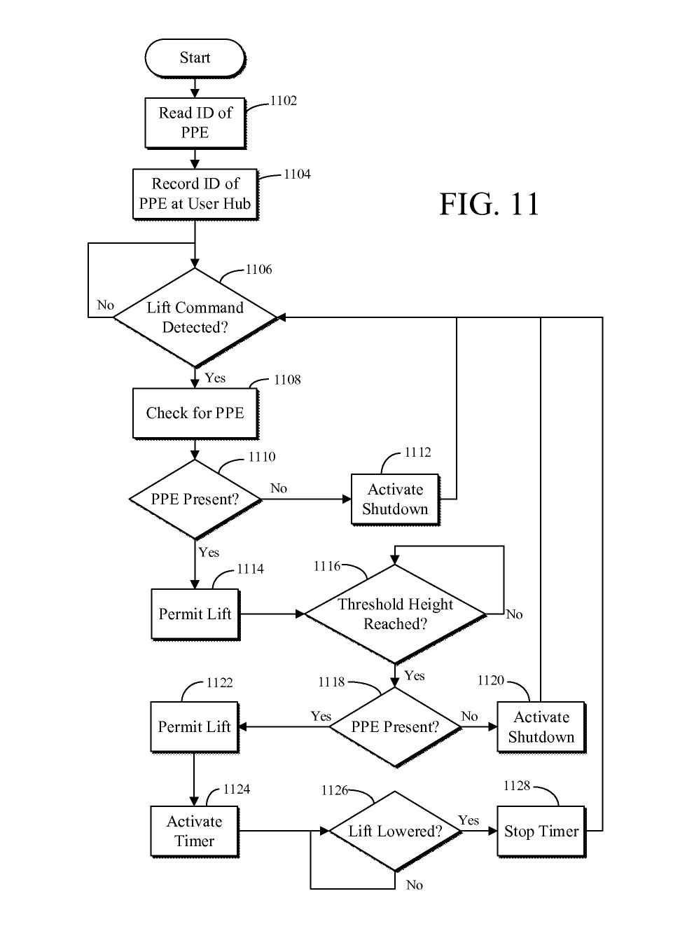

One exemplary method for the operation of an aerial work platform is illustrated in FIG. 11. To set up the system, for example when an aerial work platform is being rented to a customer, the identifier (such as an RFID identifier) of a required piece of personal protection equipment is read. In step 1104, the identifier is recorded at the user hub of the aerial work platform. Once the system has been set up, then in step 1106, the system determines whether there has been any instruction to initiate a lift operation. If there has been any such instruction, the user hub checks for the presence of the required personal protection equipment in step 1108 by querying the associated RFID or other near-field wireless tag using the antenna located at the operator basket.

If the user hub determines that the required personal protection equipment is not present, then in step 1112, the user hub disables the aerial work platform, for example by activating the emergency shutdown functions of the lift. Once the hub has been disabled, lifting operations can be enabled again if the required personal protection equipment is in range of the antenna at the operator basket.

If, on the other hand, the user hub determines that the required personal protection equipment is present, then in step 1114, the user hub permits the lifting operation to be initiated.

In some embodiments, the user hub may also determine whether the personal protection equipment is in fact being carried aloft in the operator basket, rather than simply having been left near the basket on the ground. In such embodiments, the user hub may determine in step 1116 when a threshold height of the operator basket has been reached, such as a height of six feet above the ground. After the threshold height has been reached, the user hub determines in step 1118 whether the personal protection equipment is still in range of the antenna mounted at the operator basket. If the personal protection equipment is now out of range, then the user hub initiates a safe shutdown in step 1120. If, on the other hand the personal protection equipment is still in range, the user hub in step 1122 permits the lifting operation to continue. In some embodiments, the user hub may issue queries at random or periodic intervals to confirm that the personal protection equipment is still present in the operator basket.

In some embodiments, the user hub is provided with a timer to measure the amount of time that an aerial work platform was in use for billing purposes. In some embodiments, such a timer may be triggered in step 1124 once the lift operation has been permitted. In step 1126, the user hub determines whether the operator basket has been lowered to a stowed position. Once the lift has been lowered to a stowed position, the user hub stops the timer in step 1128. The timer may be restarted after a new lift operation has been initiated successfully.

In some embodiments, the method may further comprise: while the operator basket is in an elevated position, periodically operating the user hub to determine whether the near-field identification tag is still within range of the antenna mounted on the operator basket; and in response to a determination that the near-field identification tag is no longer within range of the antenna, initiating an emergency shutdown of the aerial work platform.

In some embodiments, the method may comprise: receiving, at a user hub, data identifying a near-field identification tag associated with personal protection equipment; during a lift operation performed by an aerial work platform, operating the user hub to monitor whether an operator basket of the aerial work platform has reached a threshold height; in response to a determination that the aerial work platform has reached the threshold height, operating the user hub to determine whether the near-field identification tag is within range of an antenna mounted on the operator basket; and permitting the lift operation to proceed only after determining that the near-field identification tag is within range of the antenna.

The method may include monitoring to determine whether the operator basket has reached a threshold height by monitoring an amount of time over which the lift operation has been conducted.

The method of monitoring to determine whether the operator basket has reached a threshold height may be performed by measuring an angle of a boom arm supporting the operator basket. The monitoring to determine whether the operator basket has reached a threshold height may be performed using an altimeter or using an accelerometer.

In some embodiments, the method may comprise: receiving, at a user hub, data identifying a near-field identification tag associated with personal protection equipment; during a lift operation performed by an aerial work platform, operating the user hub to monitor whether an operator basket of the aerial work platform has reached a threshold height; in response to a determination that the aerial work platform has reached the threshold height, operating the user hub to determine whether the near-field identification tag is within range of an antenna mounted on the operator basket; and in response a determination that the near-field identification tag is not in range of the antenna, disabling the lift operation.

Disabling the lift operation may include activating an emergency shutdown of the aerial work platform.

In one embodiment, an aerial work platform comprises: a base, an operator basket, a boom arm mounted between the base and the operator basket, the boom arm being operative to elevate the operator basket during a lift operation; lift circuitry operative to control the lift operation of the boom arm; a near-field antenna mounted at the operator basket; a user hub in communication with the lift circuitry, the user hub having a processor and a non-transitory computer memory, wherein the computer memory stores instructions that, when executed on the processor, are operative: to store, in the computer memory, data identifying a near-field identification tag associated with personal protection equipment; to determine whether the near-field identification tag is within range of the antenna; and to disable the lift operation after determining that the near-field identification tag is not within range of the antenna.

The personal protection equipment may be a lanyard to which a near-field identification tag is affixed or a harness to which a near-field identification tag is affixed.

The user hub may further include a wireless network interface, and wherein the instructions are further operative to receive, over the wireless network interface, the data identifying the near-field identification tag.

Although features and elements are described above in particular combinations, those having ordinary skill in the art will appreciate that each feature or element can be used alone or in any combination with the other features and elements without departing from the scope or spirit of the present disclosure.

What is claimed is:

1. A method comprising:
receiving, at a user hub, data identifying a near-field identification tag associated with personal protection equipment;
receiving, at the user hub, an indication that a lift operation is being initiated at an aerial work platform having an operator basket;
operating the user hub to determine whether the near-field identification tag is within range of an antenna mounted on the operator basket; and
permitting the lift operation to proceed only after determining that the near-field identification tag is within range of the antenna.

2. The method of claim 1, further comprising determining, at the user hub, that the operator basket has reached a threshold height;
in response to the determination that the operator basket has reached a threshold height, operating the user hub to determine whether the near-field identification tag remains within range of the antenna; and
permitting the lift operation to proceed only after determining that the near-field identification tag remains within range of the antenna.

3. The method of claim 1, further comprising:
determining, at the user hub, that the operator basket has reached a threshold height;
in response to the determination that the operator basket has reached a threshold height, operating the user hub to determine whether the near-field identification tag remains within range of the antenna;
determining that the near-field identification tag is no longer in range of the antenna; and
in response to the determination that the near-field identification tag is no longer in range of the antenna, disabling the lift operation.
permitting the lift operation to proceed only after determining that the near-field identification tag remains within range of the operator basket.

4. The method of claim 3, wherein disabling the lift operation includes activating an emergency shutdown of the aerial work platform.

5. The method of claim 1, wherein the near-field identification tag is an RFID tag.

6. The method of claim 1, wherein the receiving of data identifying the near-field identification tag associated is performed over a wireless network.

7. The method of claim 1, further comprising:
receiving, at the user hub, data identifying a permitted operation area associated with the aerial work platform;
operating the user hub to determine a location of the aerial work platform; and
permitting the lift operation to proceed only after determining that the user hub is in the permitted operation area.

8. The method of claim 1, wherein the user hub is mounted on a base of the aerial work platform.

9. The method of claim 1, wherein the user hub is mounted on the operator basket of the aerial work platform.

10. The method of claim 1, wherein the aerial work platform is a cherry-picker.

11. An apparatus comprising:
a user hub having a processor, a non-transitory computer memory, and a near-field interface including an antenna mounted on an operator basket of an aerial work platform, wherein the computer memory stores instructions that, when executed on the processor, are operative:
to store, in the computer memory, data identifying a near-field identification tag associated with personal protection equipment;
to receive an indication that a lift operation is being initiated at an aerial work platform having an operator basket;
to determine whether the near-field identification tag is within range of the antenna; and
to permit the lift operation to proceed only after determining that the near-field identification tag is within range of the antenna.

12. The method of claim 11, wherein the user hub further includes a wireless network interface, and wherein the instructions are further operative to receive, over the wireless network interface, the data identifying the near-field identification tag.

13. The method of claim 12, wherein the wireless network interface operates according to one or more wireless-communication formats selected from the group consisting of radio frequency (RF), cellular wireless, time division multiple access (TDMA), code division multiple access (CDMA), frequency division multiple access (FDMA), orthogonal frequency division multiple access (OFDMA), Evolution Data Optimized (EV-DO), Long Term Evolution (LTE), Wi Fi, WiMAX, Global System for Mobile communications (GSM), general packet radio service (GPRS), and Universal Mobile Telecommunication System (UMTS).

14. The method of claim 11, wherein the near-field interface operates according to one or more wireless-communication formats selected from the group consisting of radio frequency (RF), RF in a 13.56 MHz band, RF in a 433 MHz band, RF in an 865 868 MHz band, RF in a 902 928 MHz band, RF in a 2450 5800 MHz band, RF in a 3.1 10 GHz band, Bluetooth, and Wi Fi.

15. An aerial work platform comprising:
a base,
an operator basket,
a boom arm mounted between the base and the operator basket, the boom arm being operative to lift the operator basket during a lift operation;
lift circuitry operative to control the lift operation of the boom arm;
a near-field antenna mounted at the operator basket;
a user hub in communication with the lift circuitry, the user hub having a processor and a non-transitory computer memory, wherein the computer memory stores instructions that, when executed on the processor, are operative:
to store, in the computer memory, data identifying a near-field identification tag associated with personal protection equipment;
to receive an indication that a lift operation is being initiated;
to determine whether the near-field identification tag is within range of the antenna; and
to permit the lift operation to proceed only after determining that the near-field identification tag is within range of the antenna.

16. The aerial work platform of claim 15, wherein the personal protection equipment is a lanyard to which a near-field identification tag is affixed.

17. The aerial work platform of claim 15, wherein the personal protection equipment is a harness to which a near-field identification tag is affixed.

18. The aerial work platform of claim 15, wherein the user hub further includes a wireless network interface, and wherein the instructions are further operative to receive, over the wireless network interface, the data identifying the near-field identification tag.

19. The aerial work platform of claim 18, wherein the wireless network interface operates according to one or more wireless-communication formats selected from the group consisting of radio frequency (RF), cellular wireless, time division multiple access (TDMA), code division multiple access (CDMA), frequency division multiple access (FDMA), orthogonal frequency division multiple access (OFDMA), Evolution Data Optimized (EV-DO), Long Term Evolution (LTE), Wi Fi, WiMAX, Global System for Mobile communications (GSM), general packet radio service (GPRS), and Universal Mobile Telecommunication System (UMTS).

20. The aerial work platform of claim 15, wherein the instructions are further operative:
to monitor whether an operator basket of the aerial work platform has reached a threshold height;
in response to a determination that the aerial work platform has reached the threshold height, to determine whether the near-field identification tag remains within range of the antenna; and
in response a determination that the near-field identification tag is not in range of the antenna, to disable the lift operation.
